(19) United States
(12) Patent Application Publication
(10) Pub. No.: US 2025/0175820 A1
(43) Pub. Date: May 29, 2025

(54) MULTI-PATH COMMUNICATIONS FOR USER EQUIPMENT IN CENTRALIZED UNIT AND DISTRIBUTED UNIT SPLIT ARCHITECTURE

(71) Applicant: ZTE CORPORATION, Shenzhen (CN)

(72) Inventors: Lin CHEN, Shenzhen (CN); Mengzhen WANG, Shenzhen (CN); Weiqiang DU, Shenzhen (CN); Wanfu XU, Shenzhen (CN); Tao QI, Shenzhen (CN)

(73) Assignee: ZTE CORPORATION, Shenzhen (CN)

(21) Appl. No.: 19/040,798

(22) Filed: Jan. 29, 2025

Related U.S. Application Data
(63) Continuation of application No. PCT/CN2022/109480, filed on Aug. 1, 2022.

(51) Int. Cl. H04W 24/02; H04W 76/20; H04W 92/18

(52) U.S. Cl. CPC H04W 24/02; H04W 76/20; H04W 92/18

(57) ABSTRACT

Presented are systems, methods, apparatuses, or computer-readable media for multi-path communications. A centralized unit (CU) may send, to a distributed unit (DU), the multi-path configuration information. The CU may receive, from the DU, multi-path configuration response information.

### CROSS-REFERENCE TO RELATED APPLICATION

This application claims the benefit of priority under 35 U.S.C. § 120 as a continuation of PCT Patent Application No. PCT/CN2022/109480, filed on Aug. 1, 2022, the disclosure of which is incorporated herein by reference in its entirety.

### TECHNICAL FIELD

The disclosure relates generally to wireless communications, including but not limited to systems and methods for multi-path transmissions and receptions for user equipment (UE) in a centralized unit (CU) and distributed unit (DU) split architecture.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, a method, an apparatus, or a computer-readable medium for multi-path communications. A centralized unit (CU) may send, to a distributed unit (DU), multi-path configuration information. The CU may receive, from the DU, multi-path configuration response information. In some embodiments, the multi-path configuration information may include path indication information identifying at least one of a direct path or an indirect path.

In some embodiments, the multi-path configuration information comprises mapping information may identify: an association between a F1-U tunnel of a data radio bearer (DRB) for remote wireless communication device and a Uu radio link control (RLC) channel for a relay wireless communication device; or an association between a F1-U tunnel of a data radio bearer (DRB) for anchor wireless communication device and a Uu radio link control (RLC) channel for aggregated wireless communication devices.

In some embodiments, the multi-path configuration information comprises mapping information may identify: an association between a signalling radio bearer (SRB) for remote wireless communication device and a Uu radio link control (RLC) channel for a relay wireless communication device; or an association between a signalling radio bearer (SRB) for anchor wireless communication device and a Uu radio link control (RLC) channel for aggregated wireless communication devices.

In some embodiments, the multi-path configuration information may include at least one of: an identifier of a radio bearer (RB), a uplink (UL) user plane (UP) tunnel (TNL) information, an identifier for a relay wireless communication device, an identifier for aggregated wireless communication devices, an identifier for the Uu radio link control (RLC) channel, an identifier for a path, an indication of a direct path or an indirect path, an indication of a primary path or a secondary path, an indication of a data split or data duplication, or a path activation indication.

In some embodiments, the identifier of the RB can be at least one of the identifier of DRB or SRB. In some embodiments, the multi-path configuration information with mapping information may be used by a DU to refrain from setting up an RLC channel of a relay wireless communication device or anchor wireless communication device for the DRB. In some embodiments, the multi-path configuration information with indirect path indication may be used by a DU to refrain from setting up an RLC channel of a relay wireless communication device or anchor wireless communication device for the DRB or SRB.

In some embodiments, the multi-path configuration information may be used by the DU to configure a first RLC channel of a relay wireless communication device or anchor wireless communication device for a direct path of a DRB or SRB. In some embodiments, the multi-path configuration information may include a path activation indication identifying a path as active or inactive. In some embodiments, the indication of a data split may include at least one of a data split threshold, or data split ratio.

In some embodiments, the multi-path configuration information with data split may indicate a distribution of a plurality of data packets across a first RLC channel corresponding to a direct path and a second RLC channel corresponding to an indirect path. In some embodiments, the multi-path configuration information may identify a DRB for a plurality of F1 user plane tunnels between the CU and DU.

In some embodiments, the multi-path configuration information may include uplink (UL) user plane (UP) tunnel (TNL) information for at least one of a direct path or an indirect path. In some embodiments, the multi-path configuration information may include two or more UL UP TNL information for a split DRB.

In some embodiments, the multi-path configuration response information may indicate at least one of an acceptance or a failure of a path. In some embodiments, the multi-path configuration response information may include an identifier for a path, or an indication of direct path or indirect path, or an indication of a primary path or a secondary path that is accepted or rejected. In some embodiments, the multi-path configuration response information may identify a cause of the failure of the path, or one of non-acceptance of a data packet delivery or an identifier for the path of non-acceptance.

In some embodiments, the multi-path configuration response information may indicate a failure in multi-path SRB or DRB setup, or the failure in multi-path SRB or DRB modification. In some embodiments, the multi-path configuration response information may include a downlink (DL) user plane (UP) tunnel (TNL) information for the path that is accepted. In some embodiments, the multi-path configuration information may include at least one of: a multi-path setup request, a multi-path modification request, or a multi-path release request.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a block diagram of a user equipment (UE) to network relay in accordance with an illustrative embodiment;

FIG. 4 illustrates a block diagram of user equipment (UE) aggregation in accordance with an illustrative embodiment;

FIG. 5A illustrates a block diagram of an intra-distributed unit (DU) multi-path configuration in accordance with an illustrative embodiment;

FIG. 5B illustrates a block diagram of an inter-distributed unit (DU) multi-path configuration in accordance with an illustrative embodiment;

FIG. 6 illustrates a communication diagram of multi-path configuration for different radio bearers (RBs) and multiple distributed units (DUs) in accordance with an illustrative embodiment;

FIG. 7 illustrates a communication diagram of multi-path configuration for split bearers and multiple distributed units (DUs) in accordance with an illustrative embodiment;

FIG. 8 illustrates a communication diagram of multi-path configuration for different radio bearers (RBs) and a single distributed unit (DU) in accordance with an illustrative embodiment;

FIG. 9 illustrates a communication diagram of multi-path configuration for split bearers under the same centralized unit (CU) and distributed unit (DU) in accordance with an illustrative embodiment;

FIG. 10 illustrates a communication diagram of multi-path configuration for split bearers under the same centralized unit (CU) and distributed unit (DU) for data splitting in accordance with an illustrative embodiment;

FIG. 11 illustrates a communication diagram of a multi-path signaling radio bearer (SRB) configuration under same centralized unit (CU) and distributed unit (DU) for data split or duplication in accordance with an illustrative embodiment; and

FIG. 12 illustrates a flow diagram of a flow diagram of a method for multi-path communications in accordance with an illustrative embodiment.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

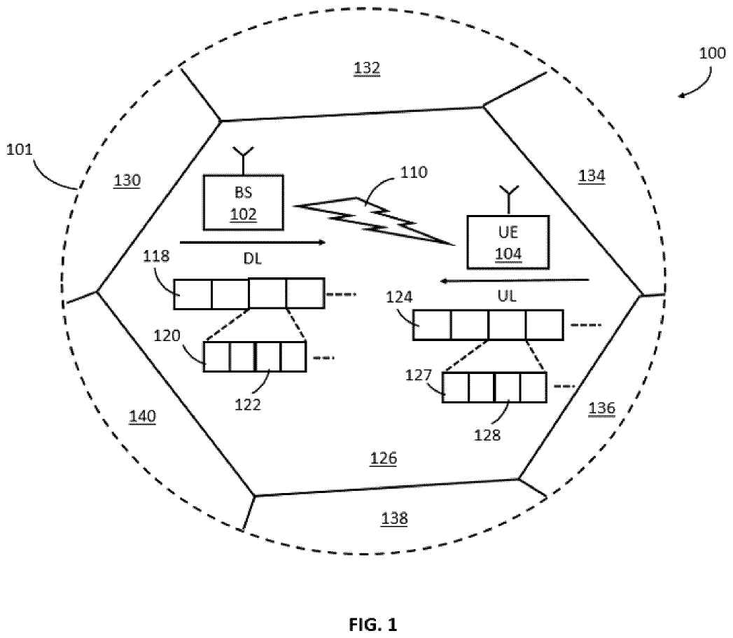

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

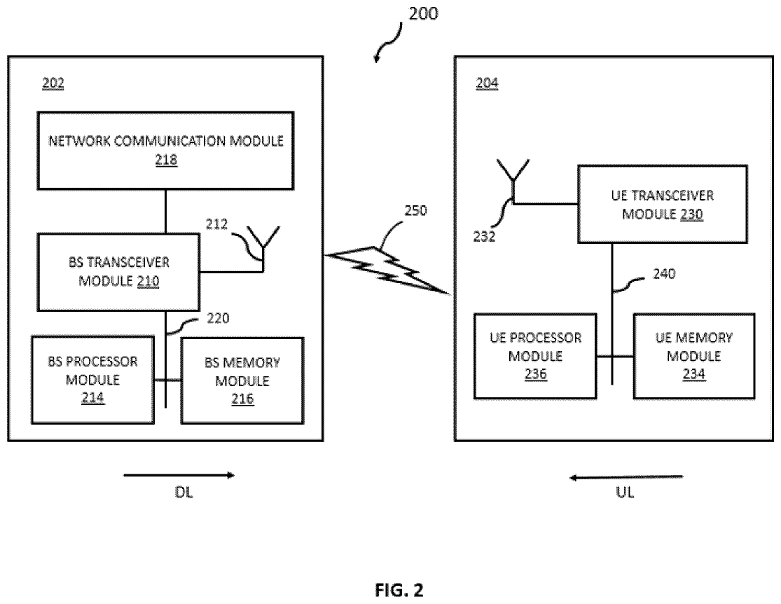

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Multi-Path Communications for User Equipment (UE) in a Centralized Unit (CU) And Distributed Unit (DU) Split Architecture

Presented herein are systems and methods for multi-path transmission and reception for UE in a CU/DU split architecture, focusing on the data split, data duplication over multi-path, and path switch between direct and indirect path.

With the development of wireless multimedia services, demands of high data rate services may significantly increase. Under such conditions, requirements of system capacity and coverage of conventional cellular network may become higher. On the other hand, due to application scenarios of public safety, social network, short distance data sharing, and local content placements, among other, demands of proximity services allowing users to acknowledge or to communicate with adjacent users or objects may also increase.

However, a cellular network may have limitations with regarding to supporting the high data rate services and the proximity services. As a result, device-to-device (D2D) communication technology may be proposed to serve such demands. By adopting the D2D technology, burden of the cellular network can be decreased, power consumption of user equipment can be reduced, and data rate can be increased and robustness of network infrastructures can be improved. The demands of the high data rate services and the proximity services may thus be fulfilled. The D2D technology may also be called a proximity service (ProSe) or sidelink communications and an interface between equipment, may be a PC5 interface.

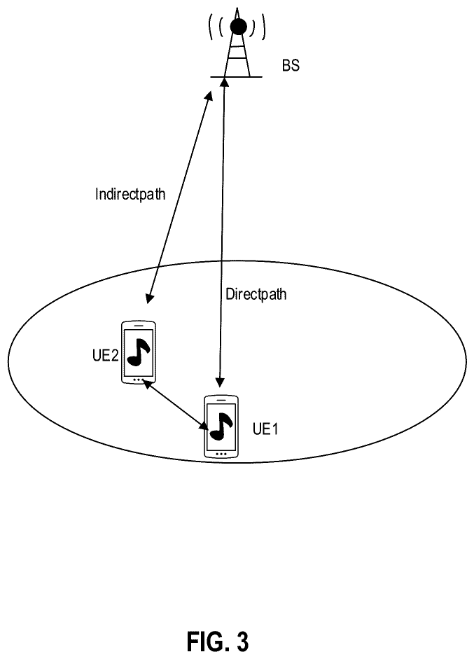

For supporting applications and services with broader ranges, a sidelink based relay communication may be used to extend the coverage and to improve power consumption of the network. For example, the sidelink based relay communication may be applied to indoor relay communication, smart farming, smart factory and public safety services. Referring now to FIG. 3, depicted is a block diagram of a user equipment (UE) to network relay. As shown, a sidelink based relay communication may involve user equipment (UE) (e.g. UE1 shown in FIG. 3) in an area with weak or no coverage. Under such a condition, the UE1 may be allowed to communicate with network (e.g. base station (BS) shown in FIG. 3) via a nearby UE2 covered by the network. As a result, the coverage of the network may be extended and the capacity of the network is enlarged. Under this scenario, the UE2 may be called UE-to-Network relay and the UE1 may be called remote UE. On the other hand, if the remote UE is in coverage, the multi-path relay can be supported. In coverage, remote UE may be connected to network via both direct (e.g., data directly transmitted between remote UE and network) and indirect (e.g., data forwarded via relay UE) paths. This may have a potential to improve the reliability and robustness as well as throughput.

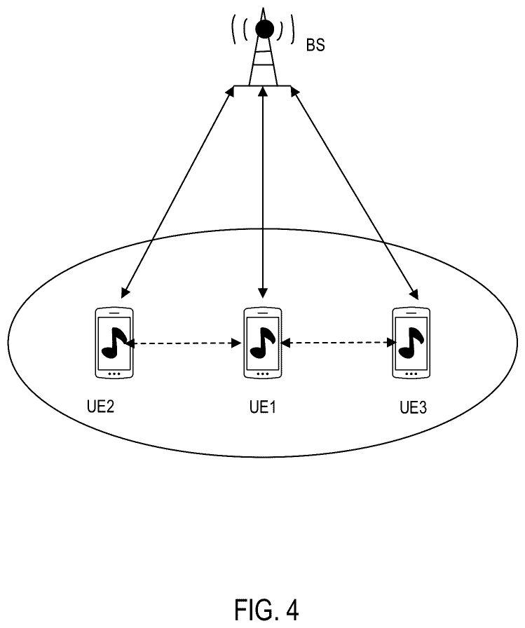

This multi-path relay approach can also be utilized for UE aggregation where a UE is connected to the network via direct path and via another UE using a non-standardized UE-UE interconnection. FIG. 4 illustrates a block diagram of user equipment (UE) aggregation. As shown, the UE aggregation may involve one user equipment (UE) (e.g., UE1 shown in FIG. 4) which aggregates other UEs (e.g. UE2 and UE3 shown in FIG. 4) for its uplink (UL) transmission or downlink reception from the network. Here the interconnection between UE1 and UE2 or between UE1 and UE3 may be based on sidelink, Wifi, Bluetooth, or wireline connection. Nevertheless, the interconnection between UEs can be ideal connection. UE aggregation may aim to provide applications requiring high UL bitrates on 5G terminals, in cases when normal UEs are too limited by UL UE transmission power to achieve required bitrate, especially at the edge of a cell. Additionally, UE aggregation can improve the reliability, stability and reduce delay of services as well.

With the development of 5G mobile wireless technology, one such technology that may be used may include a split network architecture in which the Radio Access Network (RAN) functionality is split between a centralized unit (CU) and multiple distributed units (DUs). For example, RAN functions may be split at the point between the Packet Data Convergence Protocol (PDCP) layer and the Radio Link Control (RLC) layer of the 5G protocol stack. In the stack the DUs may handle all processes up to and including the RLC layer functions and the CU may handle PDCP layer and higher layer functions prior to the core network. This disaggregation of RAN functions may provide numerous advantageous to mobile network operators. For example, through the isolation of the stack from the PDCP layer and upwards, the CU may be able to act as a cloud-based convergence point among multiple heterogeneous technologies in the provisioned networks and hence may be able to serve multiple heterogeneous DUs.

For the support of multi-path UE-to-Network relay and UE aggregation, the impact on CU/DU split architecture may be used for the multi-path support (e.g., direct path via UE and indirect path via UE-to-network relay or aggregated UE) focusing on the multi-path configuration and path switching. Under UE multi-path transmission, the UE may be limited in UL transmission (Tx) capability and one UE may be associated with many UEs for UE aggregation or connected with many relay UE for UE-to-Network relay. To support higher requirement of UL traffic, including data rate, latency, reliability, the multi-path transmission may be used. UE may be connected to the network and perform the data traffic transmission or reception with network via direct path and via one or more indirect path (e.g., data traffic forwarded by another UE). The UE-UE interconnection can be based on sidelink connection or using a non-standardized connection.

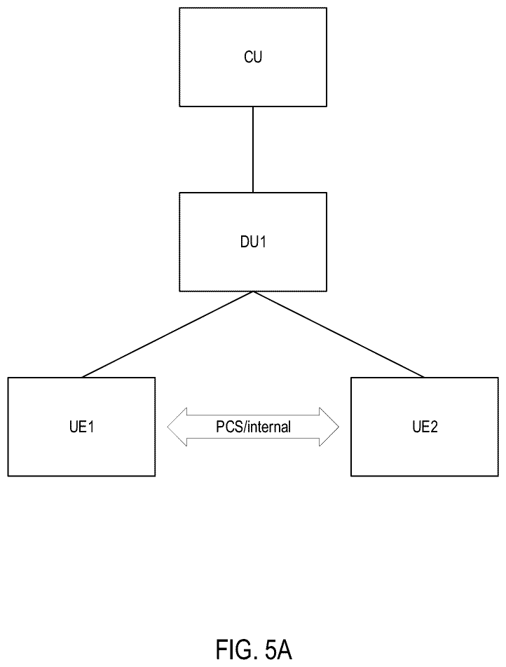

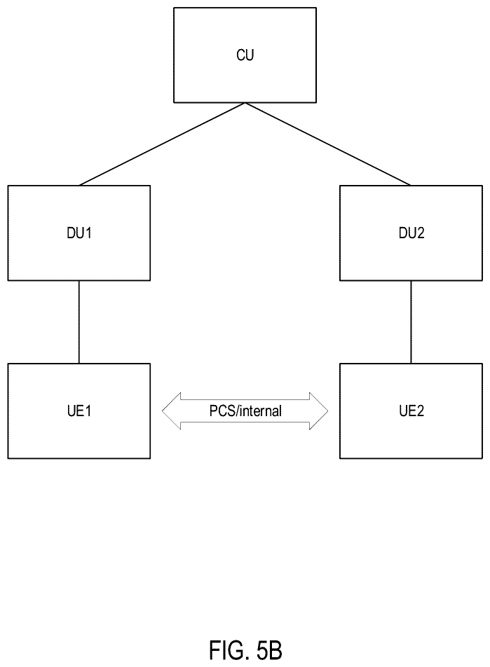

FIG. 5A illustrates a block diagram of an intra-distributed unit (DU) multi-path configuration and FIG. 5B illustrates a block diagram of an inter-distributed unit (DU) multi-path configuration. For UE connected to the same gNB using one direct path and one indirect path, the direct and indirect path may be via the same DU or different DUs. UE1 may be the remote UE or traffic originating UE or anchor UE, while UE2 may be the rely UE or aggregated UE. UE1 and UE2 may be interconnected via PC5 or internal interface. UE1 and UE2 may be served by the same DU (e.g., as in FIG. 5A) or different DUs (e.g., as in FIG. 5B). To support this multi-path scenario under CU-DU split architecture, the following issues may be examined and potential solutions are discussed herein below.

### A. Inter-Distributed Unit (DU) Scenarios

In one scenario, the UE1 and UE2 may be served by different DUs and discussed herein are the multi-path transmission configuration of UE1 between the CU and the DU.

### I. Multi-Path Configuration for Different Radio Bearers (RBs) and Multiple Distributed Units (DU)

UE1 and UE2 are served by different DUs, for the multi-path delivery of UE1's traffic. The UE1's quality of service (QoS) flows may be mapped to two bearers, data radio bearers DRB1 and DRB2. DRB1 may be delivered via a direct path while DRB2 may be delivered via indirect path (as forwarded by UE2). DRB1 and DRB2 may share the same service data adaptation protocol (SDAP) entity while separate PDCP entities may be established for DRB1 and DRB2.

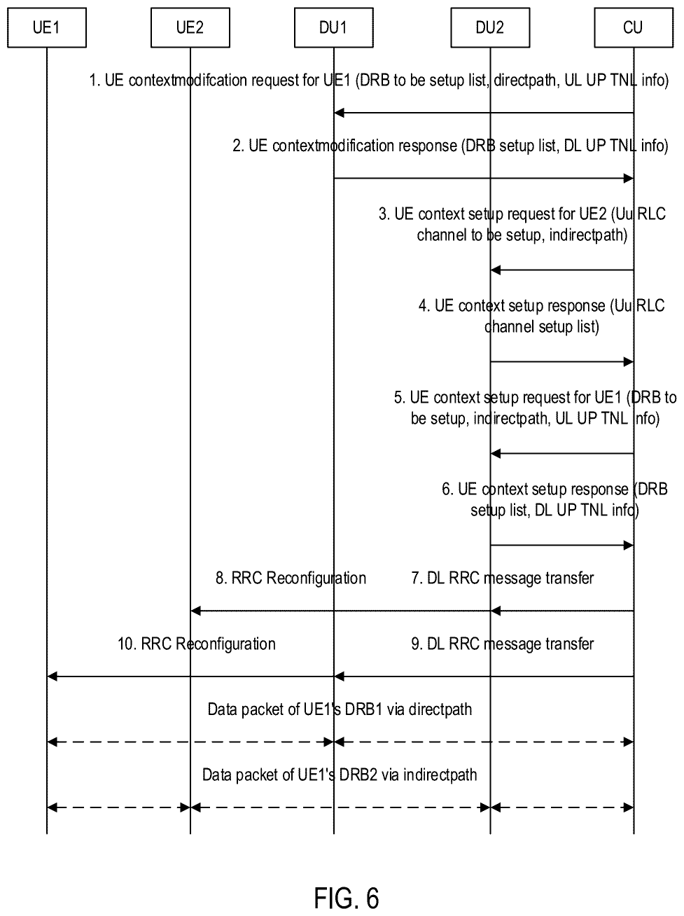

Referring now to FIG. 6, depicted is a communication diagram of multi-path configuration for different radio bearers (RBs) and multiple distributed units (DUs). The CU may request DU1 to setup the DRB1 and send the direct path indication via the UE Context Modification Request. In addition, the uplink (UL) user plane (UP) tunnel (TNL) information may be included in the UE Context Modification Request. Upon receiving the DRB1 setup request, if UL UP TNL Information information elements (IEs) are included in UE CONTEXT MODIFICATION REQUEST message for DRB1, the gNB-DU may include downlink (DL) user plane (UP) tunnel (TNL) Information IEs in UE CONTEXT MODIFICATION RESPONSE message and may setup one radio link control (RLC) entities for the DRB1 with direct path indication.

With regard to DRB2, the relevant data packet may be delivered via the relaying of UE2, so the Uu RLC channel between DU2 and UE2 is to be setup. As shown, the CU may request the DU2 to setup the Uu RLC channel via UE2-specific F1AP signalling. The CU may request the DU2 to setup the DRB2 via UE1-specific F1AP signalling. CU also send the indirect path indication, UL UP TNL information, or mapping information between the F1-U tunnel of DRB2 and the Uu RLC channel of relay UE2 to DU2. The mapping information may include any combination of the following fields: a data radio bearer identifier (DRB ID), relay UE ID or aggregated UE ID, Uu RLC channel ID.

Upon receiving the DRB2 setup request, if UL UP TNL Information IEs are included in UE CONTEXT SETUP REQUEST message for DRB2, the gNB-DU may include DL UP TNL Information IEs in UE CONTEXT SETUP RESPONSE message. However, since this DRB indicates indirect path or the mapping between the F1-U tunnel of DRB2 and the Uu RLC channel is configured, DU2 may not setup one additional RLC channel with UE1 for the DRB2. DU2 may send the response message to CU with the established DRB2 ID and logical channel identifier (LCID).

After the F1AP based configuration, the CU may send the RRCReconfiguration message that includes a configuration of DRB1, DRB2, or the path indication to UE1. In addition, the CU may send to UE2 the RRCReconfiguration message that includes the configuration of Uu RLC channel or the mapping information between Uu RLC channel and UE1's DRB.

Later, when DU2 receive the data packet from CU via the F1-U tunnel corresponding to DRB2, the DU2 may map the packet to Uu RLC channel with UE2 and deliver the data packet to UE2. Upon receiving the data packet, the UE2 may forward this packet to UE1 via internal connection or via the PC5 RLC channel.

### II. Multi-Path Configuration for Split Bearer and Multiple Distributed Units (DUs)

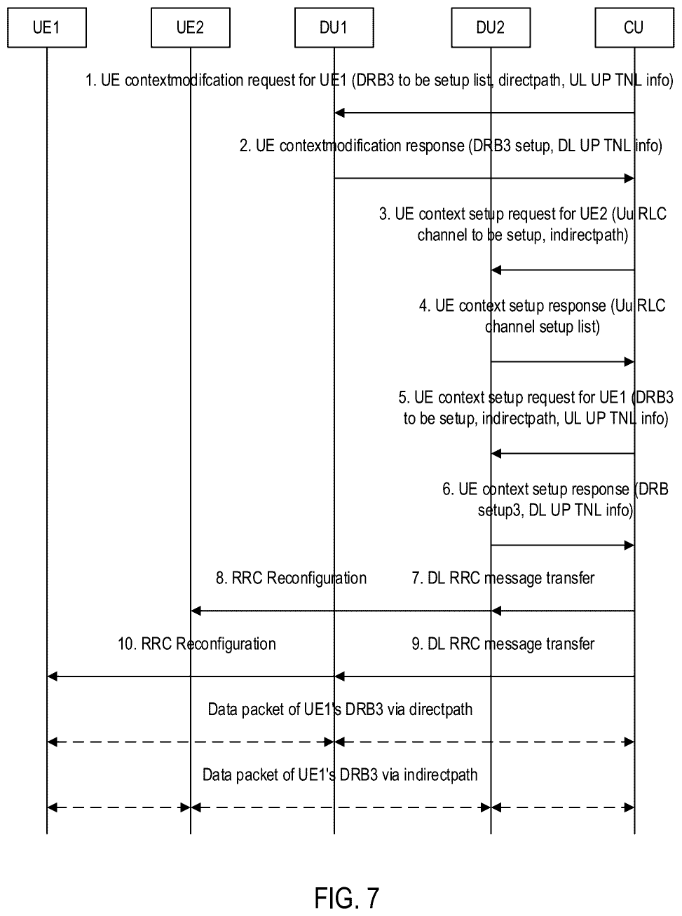

Referring now to FIG. 7, depicted is a communication diagram of multi-path configuration for split bearers and multiple distributed units (DUs). Some of UE1's QoS flows may be mapped to DRB3 and DRB3 may be configured as split bearer to be delivered via both direct path and indirect path. In this case, the CU may request the DU1 and DU2 to setup the DRB3 respectively. Two F1-U tunnels corresponding to DU1 and DU2 may be established for the DRB3. For the DL packet, the PDCP entity at CU may be responsible for the data split and deliver the split packet to the corresponding F1-U tunnel. In this way, the DU1 and DU2 may receive the packet to be delivered to UE1 via the direct path and indirect path respectively.

With DU2 as an example, the CU may request the DU2 to setup the DRB3 via UE1-specific F1AP signalling. CU may also send the indirect path indication, UL UP TNL information or mapping information between the F1-U tunnel of DRB3 and the Uu RLC channel of UE2 to DU2. The mapping information may include any combination of the following fields: DRBID, relay UE ID or aggregated UE ID, Uu RLC channel ID. Upon receiving the DRB3 setup request, if UL UP TNL Information IEs are included in UE CONTEXT SETUP REQUEST message for DRB3, the gNB-DU may include DL UP TNL Information IEs in UE CONTEXT SETUP RESPONSE message. Since this DRB indicates indirect path or the mapping between the F1-U tunnel of DRB3 and the Uu RLC channel is configured, DU2 may not setup additional RLC channel with UE1 for the DRB3. DU2 may send the response message to CU with the established DRB3 ID and LCID.

After the F1AP based configuration, the CU may send the RRCReconfiguration message that includes the configuration of DRB3, data split rule, or the indirect path mapping information UE1. In addition, the CU may send to UE2 the RRCReconfiguration message that includes the configuration of Uu RLC channel or the mapping information between Uu RLC channel of UE2 and UE1's DRB.

When DU2 receive the DL packet from F1-U tunnel corresponding to DRB3, the DU2 may detect that the packet from this F1-U tunnel is to be mapped to Uu RLC channel with UE2 (relay UE or aggregated UE). Then, the DU2 may add the adaptation layer header and deliver the packet to the Uu RLC channel with UE2 and transmit it to UE2. When UE2 receives the data packet from Uu RLC channel, the UE 2 may check the adaptation layer header and then forward the packet to UE1 via PC5 interface or internal connection.

For the UL packet, the PDCP entity at the UE1 may perform the data split based on the split rules configured by CU and deliver the packet to Uu via its own RLC channel (direct path) or to UE2 (indirect path) via PC5 interface or internal connection. When UE2 receives the data packet from UE1, the UE2 may detect the corresponding source UE and RB ID, then map the packet to the Uu RLC channel and deliver the packet to DU2. DU2 may identify the source UE ID and radio bearer (RB) ID in the adaptation layer header and detect that it is the packet for UE1's DRB3. Then, the DU2 may forward the packet to CU via the F1-U tunnel corresponding to UE1's DRB3. The data packet transmitted via indirect path may include the adaptation layer header (i.e. include UE ID and RB ID). This can be encapsulated by UE1 or UE2. For the indirect path via internal connection or PC5 connection between UE1 and UE2, the UE2 may be configured with the mapping between UE1's DRB ID and UE2's Uu RLC channel ID. DU2 may further forward the packet to CU via the F1-U tunnel. The PDCP entity of DRB3 located at CU may perform the PDCP PDU decryption, decompression and re-ordering.

### III. Multi-Path Configuration for Packet Data Convergence Protocol (PDCP) Duplication

Some of UE1's QoS flows may be mapped to DRB4. DRB4 may be configured for PDCP duplication and the packets may be delivered via both direct path and indirect path. In this case, the CU may request the DU1 and DU2 to setup the DRB4 respectively. Two F1-U tunnels corresponding to DU1 and DU2 may be established for the DRB4. For the DL packet, the PDCP entity at CU may be responsible for the data duplication and deliver the duplicated packet to the corresponding F1-U tunnel. In this way, the DU1 and DU2 may receive the packet to be delivered to UE1 via the direct path and indirect path respectively.

With DU2 as an example, the CU may request the DU2 to setup the DRB4 via UE1-specific F1AP signalling. CU also may send the primary path or secondary path indication, multi-path duplication configured, multi-path duplication activation, UL UP TNL information, or mapping information between the F1-U tunnel of DRB4 and the Uu RLC channel of UE2 to DU2. Among them, the multi-path duplication activation can be configured as active or inactive. The mapping information may include any combination of the following fields: DRBID, relay UE ID or aggregated UE ID, Uu RLC channel ID. Upon receiving the DRB4 setup request, if UL UP TNL Information IEs are included in UE CONTEXT SETUP REQUEST message for DRB4, the gNB-DU may include DL UP TNL Information IEs in UE CONTEXT SETUP RESPONSE message. Since the mapping between the F1-U tunnel of DRB4 and the Uu RLC channel is configured, DU2 may not setup one additional RLC channel with UE1 for the DRB4. DU2 may send the response message to CU with the established DRB4 ID and LCID.

After the F1AP based configuration, the CU may send the RRCReconfiguration message to UE1 which includes the configuration of DRB4, data duplication indication or the indirect path mapping information UE1. In addition, the CU may send to UE2 the RRCReconfiguration message that includes the configuration of Uu RLC channel or the mapping information between Uu RLC channel and UE1's DRB. If the DU2 receive the multi-path duplication activation as inactive, the duplicated packets received from the corresponding F1-U tunnel may be discarded.

When DU2 receive the DL packet from F1-U tunnel corresponding to DRB4, the DU2 may detect that the packet from this F1-U tunnel is to be mapped to Uu RLC channel with UE2 (relay UE or aggregated UE). Then, the DU2 may add the adaptation layer header and deliver the packet to the Uu RLC channel with UE2 and transmit it to UE2. When UE2 receives the data packet from Uu RLC channel, the DU2 may check the adaptation layer header and then forward the packet to UE1 via PC5 interface or internal connection.

With regard to the UL, the UE1 may duplicate the data packet of DRB4 and deliver the packets to DU1 and UE2 respectively. When UE2 receives the data packet from UE1, the DU2 may detect the corresponding source UE and RB ID, then map the packet to the Uu RLC channel and deliver the packet to DU2. DU2 further may forward the packet to CU via the F1-U tunnel. The PDCP entity of DRB4 located at CU may perform the PDCP PDU decryption, decompression, re-ordering and duplicated packet discard.

For the UL packet, the PDCP entity at the UE1 may perform the data duplication and deliver the packet to Uu via its own RLC channel (e.g., via the direct path) or to UE2 (e.g., via the indirect path) via PC5 interface or internal connection. When UE2 receives the data packet from UE1, the UE2 may detect the corresponding source UE and RB ID. The UE2 may then map the packet to the Uu RLC channel and deliver the pack to DU2. DU2 identify the source UE ID and RB ID in the adaptation layer header and detect that the packet is the packet for UE1's DRB4. Then, the DU2 may forward the packet to CU via the F1-U tunnel corresponding to UE1's DRB4. The data packet transmitted via indirect path may include the adaptation layer header (e.g., include UE ID and RB ID). This can be encapsulated by UE1 or UE2. DU2 may further forward the packet to CU via the F1-U tunnel. The UE2 may be configured by gNB with the mapping between UE1 DRB ID and UE2's Uu RLC channel. The PDCP entity of DRB4 located at CU may perform the PDCP PDU decryption, decompression and re-ordering.

### B. Intra-Distributed Unit (DU) Scenarios

UE1 and UE2 may be served by the same DUs, for the multi-path delivery of UE1's traffic discussed herein are the multi-path transmission configuration of UEs between the CU and the DUs.

I. Multi-Path Configuration for Different Radio Bearers (RBs) under the Same Distributed Units (DUs)

UE1 and UE2 are served by the same DUs, for the multi-path delivery of UE1's traffic, the following scenarios may be considered. The UE1's QOS flows may be mapped to two bearers, DRB1 and DRB2. DRB1 may be delivered via direct path while DRB2 may be delivered via indirect path (forwarded by UE2). DRB1 and DRB2 may share the same SDAP entity while separate PDCP entities are established for DRB1 and DRB2.

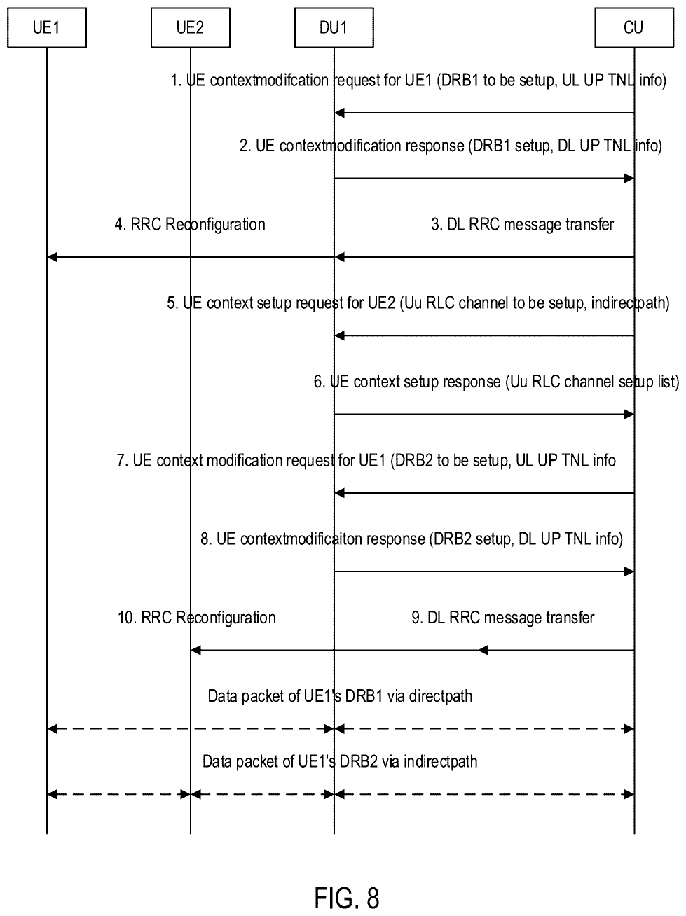

Referring now to FIG. 8, depicted is a communication diagram of a multi-path configuration for different radio bearers (RBs) and a single distributed unit (DU). As shown, the CU may request DU1 to setup the DRB1 via the UE Context Modification Request. In addition, the UL UP TNL information may be included in the UE Context Modification Request. Upon receiving the DRB1 setup request, if UL UP TNL Information IEs are included in UE CONTEXT MODIFICATION REQUEST message for DRB1, the DU1 may include DL UP TNL Information IEs in UE CONTEXT MODIFICATION RESPONSE message and setup one RLC entity for the DRB1.

With regard to DRB2, the relevant data packet may be delivered via the relaying of UE2, so the Uu RLC channel between DU1 and UE2 need to be setup. The CU may request the DU1 to setup the Uu RLC channel via UE2-specific F1AP signalling. The CU may request the DU1 to setup the DRB2 via UE1-specific F1AP signalling. CU also may send UL UP TNL information and mapping information between the F1-U tunnel of DRB2 and the Uu RLC channel of UE2 to DU1. The mapping information may include any combination of the following fields: DRB ID, relay UE ID or aggregated UE ID, Uu RLC channel ID. Upon receiving the DRB2 setup request, if UL UP TNL Information IEs are included in UE CONTEXT SETUP REQUEST message for DRB2, the DU1 may include DL UP TNL Information IEs in UE CONTEXT SETUP RESPONSE message. Since the mapping between the F1-U tunnel of DRB2 and the Uu RLC channel is configured, DU1 may not setup one additional RLC channel with UE1 for the DRB2. Instead, the Uu RLC channel of UE2 may be used for the delivery of data packet of DRB2. DU2 may send the response message to CU with the established DRB2 ID and LCID.

After the F1AP based configuration, the CU may send the RRCReconfiguration message which include the configuration of DRB1, DRB2 or the path indication to UE1. In addition, the CU may send to UE2 the RRCReconfiguration message which include the configuration of Uu RLC channel or the mapping information between Uu RLC channel and UE1's DRB.

Later when DU1 receive the data packet from CU via the F1-U tunnel corresponding to DRB2, the DU1 may map the packet to Uu RLC channel with UE2 and deliver the data packet to UE2. Upon receiving the data packet, the UE2 may forward this packet to UE1 via internal connection or via the PC5 RLC channel.

II. Multi-Path Split Bearer Configuration under the Same DU and CU for Data Split

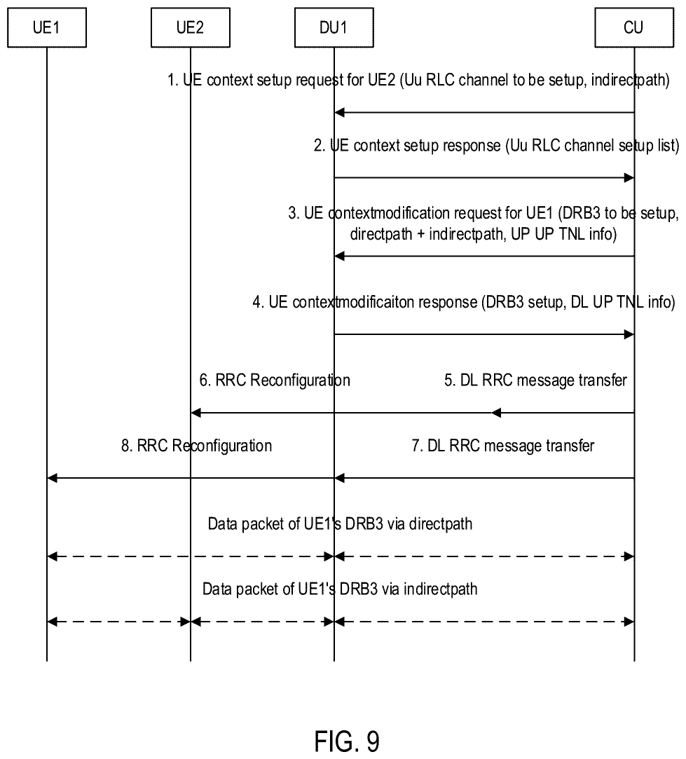

Some of UE1's QoS flows may be mapped to DRB3 and DRB3 is configured as split bearer to be delivered via both direct path and indirect path. In this case, the CU may request the DU1 to setup the DRB3. Referring now to FIG. 9, depicted is a communication diagram of multi-path configuration for split bearers under the same centralized unit (CU) and distributed unit (DU). Two F1-U tunnels corresponding to direct and indirect path may be established for the DRB3 a. For the DL packet, the PDCP entity at CU may be responsible for the data split and deliver the split packet to the corresponding F1-U tunnel. In this way, the DU1 may receive the split packet from different F1-U tunnel and then deliver them to UE1 via the direct path and indirect path respectively.

Since the data packet of DRB3 will be delivered via the relaying of UE2 (indirect path), the Uu RLC channel between DU1 and UE2 may be setup. As shown, the CU may request the DU1 to setup the Uu RLC channel via UE2-specific F1AP signalling. Then, the CU may request the DU1 to setup the DRB3 via UE1-specific F1AP signalling. CU also may send a set of path information, which may include at least one of the following info: the path ID, direct path or indirect path indication, primary path or secondary path indication, UL UP TNL information or mapping information between the F1-U tunnel of DRB3 and the Uu RLC channel of UE2 to DU1. The mapping information may include any combination of the following fields: DRB ID or UL UP TNL information, relay UE ID or aggregated UE ID, Uu RLC channel ID.

More than one UL UP TNL information may be included. One may be for the direct path, the others may be for the indirect path. Alternatively, one normal UL UP TNL information may be sent by CU to DU1 and one or more additional UL UP TNL for data split may be sent by CU to DU1. In addition, CU may also include the primary path or secondary path indication to DU1. For example, CU may indicate to DU1 that the indirect path (or one of the F1-U tunnel) is primary path and direct path (the other F1-U tunnel) is secondary path, or vice versa.

Upon receiving the DRB3 setup request, the DU1 may configure one RLC entity or logical channel for the DRB3's direct path. For the indirect path, DU1 may not setup one additional RLC channel with UE1 for the DRB3. Instead, the Uu RLC channel with UE2 may be used for the DRB3 delivery. DU1 may send the response message to CU with the established DRB3 ID and LCID. Upon receiving the DRB3 setup request, if UL UP TNL Information IEs are included in UE CONTEXT SETUP REQUEST message for DRB3, the gNB-DU may include DL UP TNL Information IEs in UE CONTEXT SETUP RESPONSE message.

If the DU1 can accept one of the data packet delivery path, the DU1 may send the response to CU to indicate which path is accepted. For example, DU1 may send the response to CU to indicate that direct path, or indirect path, or both is accepted. Alternatively, the DU1 may send the response to CU to indicate that primary path, or secondary path, or both is accepted. DU1 may also send the path ID(s) that is accepted, or the path ID that is rejected to CU. In addition, one or more corresponding DL UP TNL information may be included in the response message sent by DU1 to CU. Alternatively, if the DU1 can accept one of the data packet delivery path, DU1 may send the response to CU to indicate that the DRB failed to setup. In addition, DU1 may send to CU to indicate that the fail cause is one of the data packet delivery path is not accepted or the path id that is not accepted.

After the F1AP based configuration, the CU may send the RRCReconfiguration message that includes the configuration of DRB3, data split rule or the indirect path mapping information UE1. In addition, the CU may send to UE2 the RRCReconfiguration message that includes the configuration of Uu RLC channel or the mapping information between Uu RLC channel and UE1's DRB. After that, the data packet of DRB3 may be delivered via both direct and indirect path between UE1 and DU/CU.

III. Multi-Path Configuration for Split Bearers under the Same Centralized Unit (CU) and Distributed Unit (DU) for Data Splitting

Some of UE1's QoS flows may be mapped to DRB3 and DRB3 may be configured as split bearer to be delivered via both direct path and indirect path. In this case, the CU may request the DU1 to setup the DRB3. Compared with the scenario with multi-path split bearer configuration as discussed above, there may be one F1-U tunnel between DU1 and CU for DRB3 in this scenario. The CU may send DU1 the data split rule and DU1 may be responsible for the data split and deliver the split packet to the corresponding RLC channel.

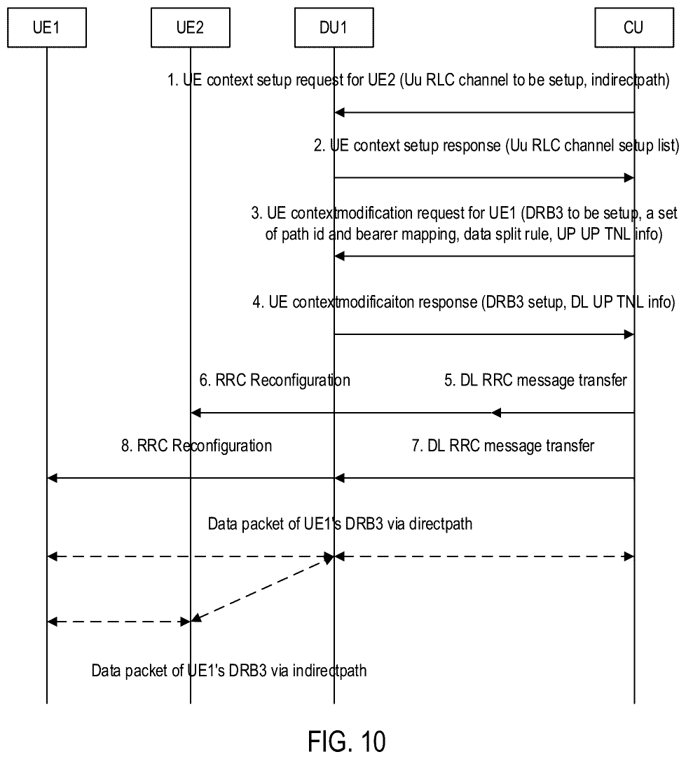

Since the data packet of DRB3 will be delivered via the relaying of UE2 (indirect path), the Uu RLC channel between DU1 and UE2 may be setup. Referring now to FIG. 10, depicted is a communication diagram of multi-path configuration for split bearers under the same centralized unit (CU) and distributed unit (DU) for data splitting. As shown, the CU may request the DU1 to setup the Uu RLC channel via UE2-specific F1AP signalling.

Then, the CU may request the DU1 to setup the DRB3 via UE1-specific F1AP signalling. CU may also send data split rule for DRB3 and a set of path information, which may include at least one of the following info: the path ID, direct path or indirect path indication, primary path or secondary path indication, or mapping information. The data split rule may include the threshold for data split or the data split ratio between the set of path. The mapping information may include any combination of the following fields: DRBID, relay UE ID or aggregated UE ID, or Uu RLC channel ID, among others. One UL UP TNL information may be included in the DRB3 setup request sent from CU to DU1.

Upon receiving the DRB3 setup request, the DU1 may configure one additional RLC entity or logical channel with UE1 for the DRB3's direct path or path not associated with bearer mapping information. For the indirect path or path associated with bearer mapping info, DU1 may not setup one additional RLC entity or logical channel with UE1 with UE1 for the DRB3. Instead, the Uu RLC channel with UE2 may be used for the DRB3 delivery. DU1 may send the response message to CU with the established DRB3 ID. Upon receiving the DRB3 setup request, if UL UP TNL Information IEs are included in UE CONTEXT SETUP REQUEST message for DRB3, the gNB-DU may include DL UP TNL Information IEs in UE CONTEXT SETUP RESPONSE message.

If the DU1 can accept one of the data packet delivery path, the DU1 may send the response to CU to indicate which path is accepted. For example, DU1 may send the response to CU to indicate that direct path, or indirect path, or both is accepted. Alternatively, the DU1 may send the response to CU to indicate that primary path, or secondary path, or both is accepted. DU1 may also send the path ID(s) that is accepted, or the path ID that is rejected to CU. In addition, one or more corresponding DL UP TNL information may be included in the response message sent by DU1 to CU. Alternatively, if the DU1 can only accept one of the data packet delivery path, DU1 may send the response to CU to indicate that the DRB failed to setup. In addition, DU1 may send to CU to indicate that the fail cause is one of the data packet delivery path is not accepted or the path id that is not accepted.

After the F1AP based configuration, the CU may send the RRCReconfiguration message that includes the configuration of DRB3, data split rule or the indirect path mapping information UE1. In addition, the CU may send to UE2 the RRCReconfiguration message that includes the configuration of Uu RLC channel or the mapping information between Uu RLC channel and UE1's DRB. After that, the data packet of DRB3 may be delivered via both direct and indirect path between UE1 and DU/CU.

When DU1 receives the DL packet from F1-U tunnel corresponding to DRB3, the DU1 may detect that the packet from this F1-U tunnel is to be split to direct path and indirect path. The direct path may be configured as primary path and indirect path may be configured as secondary path and the threshold for data split may be configured. In such a case, the DU1 may send the data packet toward direct path when the data buffer size of DRB3 is lower than threshold for data split. Otherwise, the DU1 may send the packet toward either direct path or indirect path. Alternatively, if the data split ratio is configured at DU1, the DU1 may distribute the data packet to the RLC channel corresponding to direct path or indirect path based on the data split ratio.

For the UL packet, the PDCP entity at the UE1 may perform the data split based on the split rules configured by CU and deliver the packet to Uu via its own RLC entity or logical channel (e.g., via a direct path) or to UE2 (e.g., via indirect path) via PC5 interface or internal connection. When UE2 receives the data packet from UE1, the UE2 may detect the corresponding source UE and RB ID. The UE2 may then map the packet to the Uu RLC channel and deliver the packet to DU1. DU1 identify the source UE ID and RB ID in the adaptation layer header and detect that the packet is the packet for UE1's DRB3. Then DU1 may forward the packet to CU via the F1-U tunnel corresponding to UE1's DRB3. Moreover, when DU1 receive the data packet of DRB3 from UE1, the DU1 may also forward the packet to CU via the same F1-U tunnel corresponding to UE1's DRB3. The PDCP entity of DRB3 located at CU, may perform the PDCP PDU decryption, decompression and re-ordering.

IV. Multi-Path Signaling Radio Bearer (SRB) Configuration under the Same Centralized Unit (CU) and Distributed Unit (DU) for Data Split or Duplication

The UE1's SRB2 may be configured as a duplicated or split bearer to be delivered via both direct path and indirect path. In this case, the CU may request the DU1 to setup the SRB2. The CU may send DU1 the data split rule or duplication indication and DU1 may be responsible for the data split or duplication and deliver the split or duplicated packet to the corresponding RLC channel.

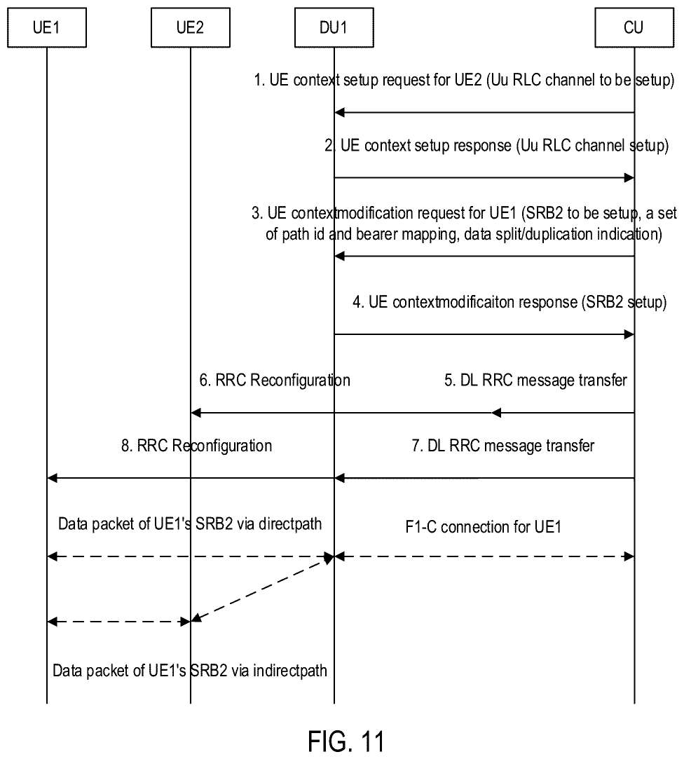

Since the data packet of SRB2 will be delivered via the relaying of UE2 (indirect path), the Uu RLC channel between DU1 and UE2 may be setup. Referring now to FIG. 11, depicted is a communication diagram for multi-path signaling radio bearer (SRB) configuration under same centralized unit (CU) and distributed unit (DU) for data split or duplication. As shown, the CU may request the DU1 to setup the Uu RLC channel via UE2-specific F1AP signalling. Then, the CU may request the DU1 to setup the SRB2 via UE1-specific F1AP signalling. CU may also send data split rule or duplication indication for SRB2 to DU1.

In addition, CU may send a set of path information, which may include at least one of the following info: the path ID, direct path or indirect path indication, primary path or secondary path indication, or mapping information. The data split rule may include the threshold for data split or the data split ratio between the set of path. The mapping information may include any combination of the following fields: SRB ID, relay UE ID or aggregated UE ID, Uu RLC channel ID.

Upon receiving the SRB2 setup request, the DU1 may configure one RLC entity or logical channel for the SRB2 if the direct path is configured or path not associated with bearer mapping info is configured. For the indirect path or path associated with bearer mapping information, DU1 may not setup one additional RLC entity or logical channel with UE1 for the SRB2. Instead, the Uu RLC channel with UE2 may be used for the DRB3 delivery. DU1 may send the response message to CU with the established SRB ID.

If the DU1 can accept one of the data packet delivery path, the DU1 may send the response to CU to indicate which path is accepted. For example, DU1 send the response to CU to indicate that direct path, or indirect path, or both, or all is accepted. Alternatively, the DU1 may send the response to CU to indicate that primary path, or secondary path, or both, or all is accepted. DU1 may also send the path ID(s) that is accepted, or the path ID that is rejected to CU. Alternatively, if the DU1 cannot accept all of the data packet delivery path, DU1 may send the response to CU to indicate that the SRB failed to setup. In addition, DU1 may send to CU to indicate that the fail cause is one of the data packet delivery path is not accepted or the path id that is not accepted.

After the F1AP based configuration, the CU may send the RRCReconfiguration message that includes the configuration of SRB2, data split rule or the indirect path mapping information UE1. In addition, the CU may send to UE2 the RRCReconfiguration message that includes the configuration of Uu RLC channel or the mapping information between Uu RLC channel and UE1's SRB. After that, the data packet of SRB2 may be delivered via both direct and indirect path between UE1 and DU/CU.

When DU1 receive the data packet for SRB2 included in the F1AP signalling to UE1, the DU1 may detect that the data packet of SRB2 is to be split or duplicated to direct path and indirect path. The threshold for data split may be configured. With the configuration, the DU1 may send the data packet toward direct path when the data buffer size of DRB3 is lower than threshold for data split. Otherwise, the DU1 may send the packet to either direct path or indirect path. Alternatively, if the data split ratio is configured at DU1, DU1 may distribute the data packet of SRB2 to the RLC channel corresponding to direct path or indirect path based on the data split ratio. On the other hand, if the data packet of SRB2 is configured to be duplicated, DU1 may perform the packet duplication and then distribute the duplicated data packet of SRB2 to the RLC entity or logical channels corresponding to both direct path or indirect path.

When UE1 initially accesses the network via direct path, the UE1's SRB via direct path may be used for signalling delivery. After a while, if the indirect path is configured, both direct path and indirect path may be available for the SRB packet delivery. The CU may send DU1 to request the DU1 to modify the SRB. The CU may send the SRB to be modified list to DU1. The list may include at least one of the following fields: SRB ID, data split rule or duplication indication, duplication activation indication, a set of path to be add or modify or release information, among others.

For the path to be add or modify information, the information may include at least one of the following info: the path ID, direct path or indirect path indication, primary path or secondary path indication, or mapping information. For the path to be release information, the information may include the path ID, direct path or indirect path indication, primary path or secondary path indication. The mapping information may include any combination of the following fields: SRB ID, relay UE ID or aggregated UE ID, Uu RLC channel ID. The duplication activation indication may indicate active or inactive. Based on the SRB modification request sent from CU, the DU1 may modify the corresponding SRB configuration and then perform the SRB packet delivery accordingly.

### V. Multiple F1-U Tunnel Configuration for UE Aggregation

For the CU/DU split scenario, multiple F1-U tunnels may be established between CU and DU for each aggregated transmissions. For example, the UE1's DRB1 traffic may be delivered via the aggregation of UE1, UE2 and UE3 and dual active protocol stack (DAPS)-like aggregation mode may be used. Under such a case, the DRBs may be configured for UE1, UE2 and UE3 for the same set of QoS flows. Here, the DAPS like aggregation mode may mean that the common PDCP entity which is responsible for the PDCP sequence number (SN) assignment or the PDCP re-ordering and duplicate discard may be established at UE1 and CU. On the other hand, separate PDCP entity responsible for the UE1's packet encryption and decryption or compression and decompression may be established at UE1, UE2 and UE3 and CU. When DU deliver the data packets from these DRBs to CU, DU may deliver the DRBs via different F1-U tunnels so that the CU may further deliver these data packets to different PDCP entities. In this sense, multiple DRBs and corresponding F1-Utunnel may be established between CU and DU for the DAPS-like aggregation for a given traffic source UEs.

For the DAPS like aggregation, the different GTP-U tunnels may be established between CU and DU for each aggregated path. Alternatively, the F1-U may be enhanced to include the path ID, or UE ID and DRB ID information, for CU to identify the corresponding PDCP entity for subsequent decryption and decompression processing.

On the other hand, for the L2 SL U2N relay based aggregation, one F1-U tunnel may be used, independent of how many paths are configured for the data delivery of a given DRB. However, CU may send the data split rule to the DU so that the DU may perform the data split and distribute the data packet to the corresponding UE's RLC channel or logical channel. With regard to duplication, the CU may also inform DU of the aggregation based duplication of the DRB. The CU may setup two GTP-U tunnels with DU which corresponding to the source and duplicated packet delivery. In this case, the UE DRB to be setup request and response may include two GTP-U tunnel configurations. One configuration may be for source packet, and another configuration may be for duplicated packet. In addition, the DU may be informed of the mapping between two GTP-U tunnel and aggregation path, UE ID, and RLC channel or logical channel ID.

### C. Path Switching

UE1 and UE2 may be served by the same DUs. The CU may configure the UE1 to use multi-path delivery of UE1's DRB or SRB. The multi-path delivery may be reconfigured based on the radio conditions and traffic load requirements. The following path switch scenarios may be considered:

I. Direct Path to and from Multi-Path

The UE1's SRB1 may be initially configured to use direct path delivery. After a while, CU may reconfigure UE1's SRB1 with multi-path delivery. For DL, CU may split or duplicate the signalling of SRB1 to two or more path. CU may request the DU to configure the Uu RLC channel and mapping rule on the indirect path. In addition, CU may request DU modify the UE1's SRB configuration, which may include the SRB ID and modified path configuration. The modified path configuration may include the path add information. The path add information configuration may include any combination of the following fields: path ID, direct path or indirect path, primary path or secondary path, path activation, and bearer mapping, among others. Then CU may split or duplicate the PDCP PDU and transmit the PDUs via multiple direct and indirect paths. From the traffic terminating UE1's perspective, the UE1 may now begin to receive the DL PDCP PDU from multiple paths. For the UL, once the anchor UE receives the configuration to switch to multiple path, the UE1 may begin to deliver the subsequent PDCP PDUs to multiple direct and indirect path.

On the other hand, CU may switch the DRB transmission of UE1 from multiple path to only use the direct path. For DL, the CU may request DU modify the UE1's DRB configuration, which may include the DRB ID and modified path configuration. The modified path configuration may include the path release information. The path release information configuration may include any combination of the following fields: path ID, direct path or indirect path, primary path or secondary path, deactivation, among others. CU or anchor UE1 no longer may deliver the DL or UL PDCP PDU to the RLC channel of indirect path. Instead, the CU or UE1 may deliver the DL or UL PDCP PDU towards the logical channel of direct path. For the packets has been delivered to the RLC channel of indirect path, the packets may still be transmitted until the RLC channel or logical channel is empty.

II. Direct Path to and from Indirect Path

For the direct path to indirect path switch, the CU or anchor UE no longer may deliver the DL or UL PDCP PDU to the RLC entity or logical channel of direct path. Instead, the CU or UE may deliver the DL or UL PDCP PDU towards the RLC channel of indirect path. To support this, the CU may request DU modify the UE1's DRB configuration, which may include the DRB or SRB ID and modified path configuration. The modified path configuration may include the indirect path add and direct path release configuration which may further include any combination of the following fields: path ID, direct path or indirect path, primary path or secondary path, path activation, or deactivation, among others. For the packets has been delivered to the RLC entity or logical channel of direct path, the packets may still be transmitted until the RLC entity or logical channel is empty. This also may apply to the indirect path to direct path switch.

III. Indirect Path to and from Multi-Path

The gNB may send the Uu RLC channel configuration to UE2. Then, the gNB may switch the data packet from UE1 to UE2. Similarly, for the uplink, the gNB may send the Uu RLC channel to UE2 and then UE1 may send the UL data packet to UE2 and UE2 forward it to gNB.

### D. Process for Multi-Path Communications

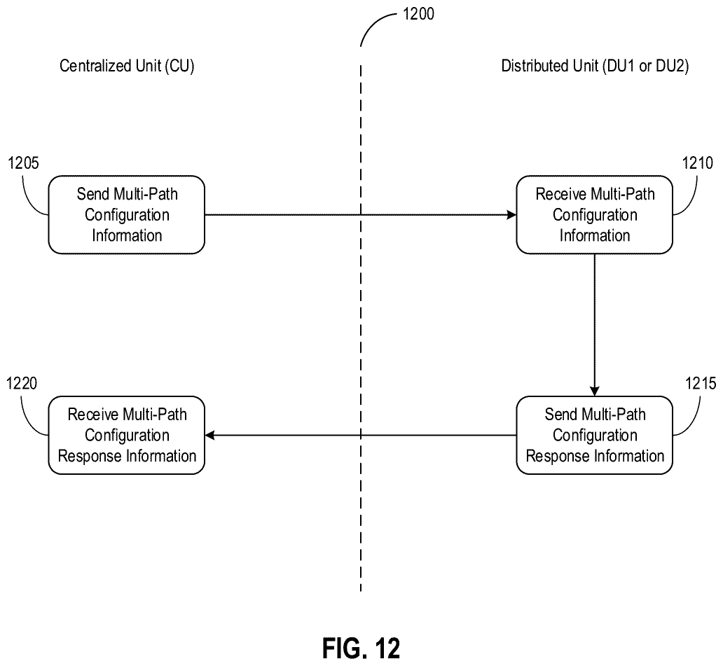

Referring now to FIG. 12, depicted is a flow diagram of a method 1200 for multi-path communications. The method 1200 may be implemented using or performed by any of the components discussed above, such as a centralized unit (CU) and one or more distributed units (DUs) of a base station 102 or 202. Under the method 1200, the CU may send multi-path configuration information (1205). A DU may receive the multi-path configuration information (1210). The DU may send multi-path configuration response information (1215). The CU may receive the multi-path configuration response information (1220).

In further detail, the CU may provide, transmit, or otherwise send multi-path configuration information to a DU (e.g., DU1 or DU2) (1205). The multi-path configuration information may include various information for adding, establishing, modifying, or releasing paths at the DU. In some embodiments, the multi-path configuration information may include a multi-path setup request to establish, add, or setup a path, a multi-path modification request to modify an existing path, or a multi-path release request to release a path. The multi-path configuration information may include or identify a path indication information. The path indication information may identify a direct path or an indirect path to be configured.

The multi-path configuration information may identify or include mapping information. In some embodiments, the mapping information may include or identify an association between a F1-U tunnel of a data radio bearer (DRB) for a remote UE (e.g., UE 104 or 204) and a Uu radio link control (RLC) channel for a relay UE (e.g., UE 104 or 204). In addition, the mapping information may include an association between a signalling radio bearer (SRB) for the remote UE and a Uu radio link control (RLC) channel for the relay UE. The remote UE (or a remote wireless communication device) may be connected to the base station via the relay UE (or a relay wireless communication device) that is connected directly to the base station.

In some embodiments, the mapping information may include or identify an association between the F1-U tunnel of the DRB for an anchor UE (e.g., UE 104 or 204) and a Uu RLC channel for aggregated UEs. In some embodiments, the mapping information may include or identify an association between a signalling radio bearer (SRB) for an anchor wireless communication device and a Uu radio link control (RLC) channel for aggregated wireless communication devices. The aggregate UEs (or aggregate wireless communication devices) may be connected with the base station through another UE (e.g., an anchor UE or anchor wireless communication device) or with the base station.

In addition, the multi-path configuration information may include or identify various identifiers. In some embodiments, the multi-path configuration information may include an identifier for a path (e.g., indirect or direct path) to be configured (e.g., added, modified, or released). In some embodiments, the multi-path configuration information may include an identifier of a radio bearer (RB). The identifier may be for a data radio bearer (DRB) or a signaling radio bearer (SRB) for the path to be configured.

Continuing on, the multi-path configuration information may include or identify identifiers for UEs. In some embodiments, the multi-path configuration information may include an identifier for a relay UE. The relay UE may be connected directly to the base station, and may support indirect connections for remote UEs. In some embodiments, the multi-path configuration information may include an identifier for aggregated UEs. The aggregated UEs may include a set of UEs that are connected to one another and connected with the base station.

The multi-path configuration information may include or identify various indicators associated with the path to be configured. In some embodiments, the multi-path configuration information may include an indication of a path as a direct path or an indirect path. The direct path may be a direct link between the UE and the base station. In some embodiments, the multi-path configuration information may include an indication of the path as a primary path or a secondary path. The primary path may correspond to a path via which packet transmission is prioritized over the secondary path. In some embodiments, the multi-path configuration information may include a path activation indication. The path activation indication may identify whether the path is to be active or inactive to receive data packets.

In some embodiments, the multi-path configuration information may include an indication of a data split or duplication for one or more paths. The data split may specify division of packets across direct and indirect paths. The data duplication may specify copying of the packets when transmitted via the direct and in direct paths. In some embodiments, the indication of the data split may identify a data split threshold or a data split ratio. The data split threshold may define an amount of data at which to initiate data splitting over the paths. The data split ratio may define a ratio of the amount of data communicated over the paths. In some embodiments, the multi-path configuration information may define, identify, or indicate a distribution of data packets over a direct path (e.g., corresponding to a first RLC channel) and an indirect path (e.g., corresponding to a second RLC channel) for data splitting.

The multi-path configuration information may include or identify tunnel information. In some embodiments, the multi-path configuration information may identify or include a uplink (UL) user plane (UP) tunnel (TNL) information. In some embodiments, the UL UP TNL information may be for a direct path or an indirect path. The UL UP TNL information may be included for a particular DRB. In some embodiments, multiple sets of UL UP TNL information may be for a split DRB. In some embodiments, the multi-path configuration information may include an identifier for the Uu radio link control (RLC) channel for use. The Uu RLC channel of a UE may be mapped to a F1-U tunnel of a DRB. In some embodiments, the multi-path configuration information may identify a DRB (e.g., using the DRB ID) for a set of F1-U tunnels between the CU and DU.

The DU may retrieve, identify, or otherwise receive the multi-path configuration information from the CU (1210). Upon receipt, the DU may parse the multi-path configuration information to extract or identify various information, such as the mapping information. The DU may use the multi-path configuration to configure a direct path or a path not associated with the mapping information (e.g., using the DRB or SRB). The direct path or non-associated path may corresponding to an RLC channel. In some embodiments, the DU may use the multi-path configuration information to configure a RLC channel of a relay UE or an anchor UE for a direct path of the DRB or SRB.

On the other hand, the DU may use the multi-path configuration to refrain from setting up an additional RLC channel for the RB, such as the DRB or SRB. The additional RCL channel may be for an indirect path. In some embodiments, the DU may use the mapping information to refrain from setting up an RCL channel of a relay UE or an anchor UE for the DRB. In some embodiments, the DU may use the indirect path indirection to refrain from setting up an RLC channel of the relay UE or anchor UE for the DRB or SRB.

The DU may provide, transmit, or otherwise send multi-path configuration response information to the CU (1215). In using the multi-path configuration information, the DU may generate the multi-path configuration response information. The CU may retrieve, identify, or otherwise receive the multi-path configuration response information from the DU (1220). In some embodiments, the multi-path configuration response information may identify or include a downlink (DL) user plane (UP) tunnel (TNL) information for the path that is configured. The path may correspond to the one that is accepted at the DU.

In some embodiments, the multi-path configuration response information may identify or include an identifier for a path. The path may correspond to the one configured using the multi-configuration information. In some embodiments, the multi-path configuration response information may identify or include an indication of a direct path or an indirect path. The indirect or direct path may correspond to the one configured using the multi-configuration information. In some embodiments, the multi-path configuration response information may identify or include an indication of a primary path or a secondary path that is accepted or rejected.

In some embodiments, the multi-path configuration response information may identify or indicate an acceptance or a failure of a path. The indication and related information may be generated and provided by the DU. In some embodiments, the multi-path configuration response information may include or identify a cause of the failure of the path. The cause may include, for example, non-acceptance of a data packet delivery over the path or an identifier for the path that was not accepted, among others. In some embodiments, the multi-path configuration response information may identify or indicate a failure in a multi-path SRB or DRB setup. In some embodiments, the multi-path configuration response information may identify or indicate a failure in a multi-path SRB or DRB modification.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method of multi-path communications, comprising:
sending, by a centralized unit (CU) to a distributed unit (DU), multi-path configuration information; and
receiving, by the CU from the DU, multi-path configuration response information.

2. The method of claim 1, wherein the multi-path configuration information comprises path indication information identifying at least one of a direct path or an indirect path.

3. The method of claim 1, wherein the multi-path configuration information comprises mapping information identifying:
an association between a F1-U tunnel of a data radio bearer (DRB) for remote wireless communication device and a Uu radio link control (RLC) channel for a relay wireless communication device; or
an association between a F1-U tunnel of a data radio bearer (DRB) for anchor wireless communication device and a Uu radio link control (RLC) channel for aggregated wireless communication devices.

4. The method of claim 1, wherein the multi-path configuration information comprises mapping information identifying:
an association between a signalling radio bearer (SRB) for remote wireless communication device and a Uu radio link control (RLC) channel for a relay wireless communication device; or
an association between a signalling radio bearer (SRB) for anchor wireless communication device and a Uu radio link control (RLC) channel for aggregated wireless communication devices.

5. The method of claim 1, wherein the multi-path configuration information comprises at least one of: an identifier of a radio bearer (RB), a uplink (UL) user plane (UP) tunnel (TNL) information, an identifier for a relay wireless communication device, an identifier for aggregated wireless communication devices, an identifier for the Uu radio link control (RLC) channel, an identifier for a path, an indication of a direct path or an indirect path, an indication of a primary path or a secondary path, an indication of a data split or data duplication, or a path activation indication.

6. The method of claim 5, wherein the identifier of the RB can be at least one of the identifier of a data radio bearer (DRB) or signalling radio bearer (SRB).

7. The method of claim 3, wherein the multi-path configuration information with mapping information is used by a DU to refrain from setting up an RLC channel of a relay wireless communication device or anchor wireless communication device for the DRB.

8. The method of claim 5, wherein the multi-path configuration information with indirect path indication is used by a DU to refrain from setting up an RLC channel of a relay wireless communication device or anchor wireless communication device for a data radio bearer (DRB) or signalling radio bearer (SRB).

9. The method of claim 1, wherein the multi-path configuration information is used by the DU to configure a first RLC channel of a relay wireless communication device or anchor wireless communication device for a direct path of a data radio bearer (DRB) or signalling radio bearer (SRB).

10. The method of claim 1, wherein the multi-path configuration information with data split indicates a distribution of a plurality of data packets across a first RLC channel corresponding to a direct path and a second RLC channel corresponding to an indirect path.

11. The method of claim 1, wherein the multi-path configuration information identifies a data radio bearer (DRB) for a plurality of F1 user plane tunnels between the CU and DU.

12. The method of claim 1, wherein the multi-path configuration information comprises uplink (UL) user plane (UP) tunnel (TNL) information for at least one of a direct path or an indirect path.

13. The method of claim 1, wherein the multi-path configuration information comprises two or more UL UP TNL information for a split data radio bearer (DRB).

14. A centralized unit (CU), comprising:
at least one processor configured to:
send, via a transceiver to a distributed unit (DU), multi-path configuration information; and
receive, via the transceiver from the DU, multi-path configuration response information.

15. A method of multi-path communications, comprising:
receiving, by a distributed unit (DU) from a centralized unit (CU), multi-path configuration information; and
sending, by the DU to the CU, multi-path configuration response information.

16. A distributed unit (DU), comprising:
at least one processor configured to:
receive, via a transceiver from a centralized unit (CU), multi-path configuration information; and
send, via the transceiver to the CU, multi-path configuration response information.

17. The DU of claim 16, wherein the multi-path configuration information comprises path indication information identifying at least one of a direct path or an indirect path.

18. The DU of claim 16, wherein the multi-path configuration information comprises mapping information identifying:
an association between a F1-U tunnel of a data radio bearer (DRB) for remote wireless communication device and a Uu radio link control (RLC) channel for a relay wireless communication device; or
an association between a F1-U tunnel of a data radio bearer (DRB) for anchor wireless communication device and a Uu radio link control (RLC) channel for aggregated wireless communication devices.

19. The DU of claim 16, wherein the multi-path configuration information comprises mapping information identifying:
an association between a signalling radio bearer (SRB) for remote wireless communication device and a Uu radio link control (RLC) channel for a relay wireless communication device; or
an association between a signalling radio bearer (SRB) for anchor wireless communication device and a Uu radio link control (RLC) channel for aggregated wireless communication devices.

20. The DU of claim 16, wherein the multi-path configuration information comprises at least one of: an identifier of a radio bearer (RB), a uplink (UL) user plane (UP) tunnel (TNL) information, an identifier for a relay wireless communication device, an identifier for aggregated wireless communication devices, an identifier for the Uu radio link control (RLC) channel, an identifier for a path, an indication of a direct path or an indirect path, an indication of a primary path or a secondary path, an indication of a data split or data duplication, or a path activation indication.
